(19) United States
(12) Patent Application Publication
(10) Pub. No.: US 2005/0032959 A1
(43) Pub. Date: Feb. 10, 2005

(54) Filled thermoplastic olefin composition

(76) Inventors: Yunwa Wilson Cheung, Lake Jackson, TX (US); Brian W. Walther, Clute, TX (US); Jeffrey M. Cogen, Flemington, NJ (US)

Correspondence Address: WHYTE HIRSCHBOECK DUDEK S.C., 555 EAST WELLS STREET, SUITE 1900, MILWAUKEE, WI, 53202, US

(21) Appl. No.: 10/838,278

(22) Filed: May 4, 2004

Related U.S. Application Data
(60) Provisional application No. 60/468,027, filed on May 5, 2003.

(51) Int. Cl. C08K 3/26; C08K 3/18

(52) U.S. Cl. 524/425; 524/430

(57) ABSTRACT

A filled thermoplastic olefin composition comprising (a) a first polypropylene having (i) substantially isotactic propylene sequences, (ii) a narrow molecular weight distribution, and (iii) a broad composition distribution, and (b) at least about 20 percent by volume filler based on the total volume of the composition. Optionally, the composition can comprise a second polypropylene different for the first polypropylene, both polypropylenes preferably propylene/α-olefin copolymers. The filler can be organic or inorganic, and the compositions are useful as, among other applications, protective coverings for wire and cable.

### CROSS-REFERENCE TO RELATED APPLICATION

This application claims the benefit of U.S. Provisional Application Ser. No. 60/468,027 filed on May 5, 2003, the teachings and disclosures of which are incorporated herein by reference.

### FIELD OF THE INVENTION

The field of this invention is filled thermoplastic olefin compositions, and in particular filled thermoplastic olefin compositions containing propylene/α-olefin copolymers.

### BACKGROUND OF THE INVENTION

Highly filled polymer systems are used extensively in commercial applications, such as flame retardant (FR) applications, sound management applications, wire and cable applications, polymer master batches, roofing membranes, wall coverings, and automotive applications.

It would be desirable to utilize very high levels of filler for these applications, typically greater than 20 percent by volume, preferably greater than 25 percent by volume, further more preferably greater than 30 percent by volume, even more preferably greater than 40 percent by volume, and if achievable, greater than 55 percent by volume filler. However, few polymer compositions are able to incorporate these levels of filler, while still maintaining the performance properties necessary to effectively fabricate the filled polymer compositions into fabricated articles. In particular, propylene-based polymer compositions have not been available that can incorporate the required level of fillers while still maintaining the desired physical properties, such as flexibility, tensile strength, extensibility, elongation, heat resistance, low temperature flexibility, and thermoformability and thermostability during processing.

What is desired is a propylene-based polymer composition that is capable of incorporating large quantities of inorganic and/or organic filler, while simultaneously exhibiting an enhanced balance of physical properties for the applications of interest.

### SUMMARY OF THE INVENTION

Surprisingly, the inventors have found that a filled thermoplastic olefin composition containing (a) a propylene/α-olefin copolymer having substantially isotactic propylene sequences and exhibiting a narrow molecular weight distribution and broad composition distribution, and (b) at least 20 percent by volume filler, preferably at least 25 percent by volume filler, more preferably at least 30 percent by volume filler, further more preferably at least 40 percent by volume filler, and for some applications, preferably greater than 55 percent by volume filler, provides an excellent balance of physical properties, such as puncture resistance, tear and tensile strength, flexibility, heat resistance and low temperature flexibility, and further provides enhanced thermoformability and thermostability during processing.

In a first aspect, the invention is a filled thermoplastic olefin composition comprising: (a) a propylene/α-olefin copolymer having (i) at least 60 percent by weight units derived from propylene and preferably at least 5 percent by weight units derived from an α-olefin, (ii) a molecular weight distribution less than or equal to 3.5 (≦3.5), and (iii) a broad composition distribution, and (b) at least 25 percent by volume of an organic or inorganic filler based on the volume of the total composition (i.e., the combined volume of the filler, thermoplastic olefin and any other composition components). The filled thermoplastic composition displays improved physical properties, such as, low temperature flexibility, high elongation, high ultimate tensile strength, low modulus, extensibility, heat resistance, flexibility, low Shore A hardness, high thermostability during processing and excellent sound barrier properties. Additionally, the filled blends of the invention are capable of being processed at a high temperature without significant polymer degradation and/or gel formation. Still further, the propylene/α-olefin copolymers used in the practice of this invention are capable of incorporating a high level of filler without the need for a coupling agent.

In a second aspect, the invention is a filled thermoplastic olefin composition, comprising: (a) a first polypropylene comprising a propylene/α-olefin copolymer having (i) at least 60 percent by weight units derived from propylene and from about 3 to about 40 percent by weight of units derived from an α-olefin, (ii) a molecular weight distribution ≦3.5, and (iii) a broad composition distribution, (b) a second polypropylene different from the first polypropylene, the second polypropylene preferably having from about 5 to about 30 percent by weight units derived from an α-olefin (preferably, the second polypropylene is also a propylene/α-olefin copolymer having (i) at least 60 percent by weight units derived from propylene, and from about 8 to about 14 percent by weight of units derived from an α-olefin, (ii) a molecular weight distribution of ≦3.5, and (iii) a broad composition distribution); and (c) at least 25 percent by volume of an organic or inorganic filler based on the volume of the total composition (i.e., the combined volume of the filler, thermoplastic olefins and any other composition components). In this aspect, the filler level can be maintained relatively high with respect to those achievable in the first aspect of the invention, while at the same time providing a higher modulus article with improved flexibility. In addition to the above listed benefits, articles made from the filled compositions of this second aspect of the invention will likely exhibit better heat resistance than articles made from the filled compositions of the first aspect of the invention.

In a third aspect, the invention is a flame retardant composition comprising: (a) a propylene/α-olefin copolymer having (i) at least 60 percent by weight units derived from propylene and preferably from about 5 to about 15 percent by weight units derived from an α-olefin, (ii) a molecular weight distribution of ≦3.5, and (iii) a broad composition distribution; and (b) at least 20 percent by volume of an organic or inorganic flame retardant filler based on the volume of the total composition (i.e., the combined volume of the filler, thermoplastic olefin and any other composition components). Preferably, the flame retardant filler is an inorganic filler, e.g., magnesium dihydroxide, aluminum trihydroxide, silica, alumina, titanium oxides, talc, clay or nanoclay, organo-modified clay or nanoclay, zinc borate, antimony trioxide, wollastonite, calcium hydroxide, calcium carbonate, mica or a mixture of more than one of the above. The flame retardant filler preferably makes up at least 25, more preferably at least 30 and even more preferably at least 55, percent by volume of the composition.

One particularly preferred application for the flame retardant thermoplastic olefin compositions of this invention is the insulating, jacketing or otherwise protecting or coating of wires, cables, optical fibers and other cable components. Suitable wire and cable constructions, which may be made by applying the coating over a wire or a cable, include: (a) insulation and jacketing for copper telephone cable, coaxial cable, and medium and low voltage power cable, and (b) fiber optic buffer and core tubes. Other examples of suitable wire-and-cable constructions are described in ELECTRIC WIRE HANDBOOK (J. Gillett & M. Suba, eds., 1983), and POWER AND COMMUNICATION CABLES THEORY AND APPLICATIONS (R. Bartnikas & K. Srivastava, eds., 2000). Additional examples of suitable wire and cable constructions are readily apparent to persons of ordinary skill in the art. Any of these constructions can be advantageously coated with a composition of the present invention.

### BRIEF DESCRIPTION OF THE DRAWING

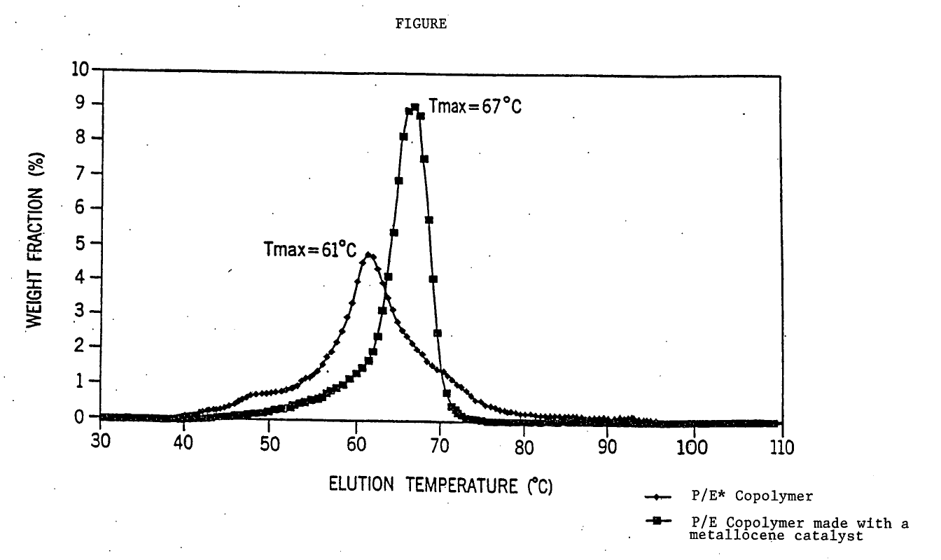

The Figure (which is FIG. 5 of U.S. Ser. No. 10/289,168) is a representation of the typical type of distribution one would expect for (i) a propylene/ethylene copolymer made with a metallocene catalyst, and (ii) a propylene/α-olefin copolymer (a P/E* copolymer) described in U.S. Ser. No. 10/289,168.

### DEFINITIONS

“Tₘₑ” means the temperature at which the melting ends as determined by the differential scanning calorimetry procedure described in allowed patent application U.S. Ser. No. 10/289,168.

“Tₘₐₓ” means the peak melting temperature as determined by the differential scanning calorimetry procedure described in allowed patent application U.S. Ser. No. 10/289,168.

“Metallocene-catalyzed polymer” or similar term means any polymer that is made in the presence of a metallocene catalyst

“Random copolymer” means a copolymer in which the comonomer is randomly distributed across the polymer chain.

“Propylene random copolymer” means a random copolymer of propylene and an α-olefin other than propylene comprising at least sixty percent by weight units derived from propylene.

“Impact polymer composition” means a composition comprising two or more polymers in which one polymer is dispersed in the other polymer, typically one polymer comprising a matrix phase and the other polymer comprising an elastomer phase. The matrix polymer is typically a crystalline polymer, e.g., polypropylene homopolymer or polypropylene copolymer, and the polymer comprising the elastomer phase is typically a rubber or an elastomer, e.g., an ethylene-propylene (EP) or an ethylene-propylene-diene monomer (EPDM) rubber. The polymer that forms the elastomer phase typically comprises between about 5 and about 50, preferably between about 10 and 45 and more preferably between about 10 and 40, weight percent of the impact polymer composition.

“Propylene impact polymer composition” refers to an impact polymer composition in which a polypropylene copolymer or propylene homopolymer forms the matrix of the composition.

“Propylene homopolymer” and similar terms mean a polymer consisting all or substantially all of units derived from propylene. “Polypropylene copolymer” and similar terms mean a polymer comprising units derived from propylene and an α-olefin other than propylene, e.g., ethylene and/or one or more C₄₋₂₀ α-olefin.

“Copolymer” means a polymer comprising two or more comonomers, and specifically includes terpolymers, tetrapolymers, etc.

“Polypropylene” means a propylene homopolymer, propylene random copolymer, a polypropylene copolymer or a propylene impact polymer composition.

“P/E*” means a copolymer of propylene and an α-olefin, preferably ethylene, and, optionally, one or more unsaturated comonomers, e.g., a second α-olefin, particularly a C₄₋₂₀ α-olefin, a C₄₋₂₀ diene, a vinyl aromatic compound (e.g., styrene), etc. These copolymers are characterized as comprising at least about 60 weight percent (wt%) of units derived from propylene, about 0.1-35 wt% of units derived from an α-olefin, and 0 to about 35 wt% of units derived from one or more other unsaturated comonomers, with the proviso that the combined weight percent of units derived from the α-olefin and the other unsaturated comonomer does not exceed about 40. These copolymers are also characterized as having at least one of the following properties: (i) ¹³C NMR peaks corresponding to a regio-error at about 14.6 and about 15.7 ppm, the peaks of about equal intensity, (ii) a DSC curve with a Tₘₑ that remains essentially the same and a Tₘₐₓ that decreases as the amount of comonomer, i.e., the units derived from ethylene and/or the unsaturated comonomer(s), in the copolymer is increased, and (iii) a skewness index, Sᵢₓ, greater than about −1.20. In addition, some of these copolymers can be further characterized as having at least one of a (iv) B-value greater than about 1.4 when the comonomer content, i.e., the units derived from ethylene and/or the unsaturated comonomer(s), of the copolymer is at least about 3 wt%, and (v) an X-ray diffraction pattern that reports more gamma-form crystals than a comparable copolymer prepared with a Ziegler-Natta (Z-N) catalyst. Typically the P/E* polymers are characterized by at least two of these properties. Certain of these polymers are characterized by at least three of these properties, while other of these polymers are characterized by at least four or even all five of these properties.

“Broad composition distribution” means a skewness index of greater than about −1.2, preferably greater than about 0, and more preferably greater than about 1.

“Masterbatch” means a previously prepared mixture comprised of a base material, i.e., the polypropylene, and a high percentage of an ingredient, e.g., a filler, that is important to a product under manufacture. Aliquot parts of this mixture are added to production-size quantities (batches) during the mixing operation. For example, masterbatches of organic dyes dispersed in a plastic are prepared by manufacturers of colorants for direct use.

All reference to the Periodic Table of the Elements shall refer to the Periodic Table of the Elements, published and copyrighted by CRC Press, Inc., 2001. Also, any reference to a Group or Groups shall be to the Group or Groups as reflected in this Periodic Table of the Elements using the IUPAC system for numbering groups. For purposes of United States patent practice, the contents of any patent, patent application or publication referenced herein is hereby incorporated by reference in its entirety, especially with respect to the disclosure of analytical or synthetic techniques and general knowledge in the art.

The terms “comprising”, “having”, “including” and similar terms are not intended to exclude the presence of any additional component, step or procedure, whether or not the same is disclosed. in order to avoid any doubt, all compositions claimed through use of the term “comprising” and the like may include any additional additive, adjuvant or compound, whether polymeric or otherwise, unless stated to the contrary. In contrast, the term “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

The term “hetero” or “hetero-atom” refers to a non-carbon atom, especially Si, B, N, P or O. “Heteroaryl”, “heteroalkyl”, “heterocycloalkyl” and “heteroaralkyl” refer to aryl, alkyl, cycloalkyl, or aralkyl groups respectively, in which at least one carbon atom is replaced by a heteroatom. “Inertly substituted” refers to substituents on a ligand that do not destroy operability of the invention. Preferred inert substituents are halo, di(C₁₋₆ hydrocarbyl)amino, C₂₋₆ hydrocarbyleneamino, C₁₋₆ halohydrocarbyl, and tri(C₁₋₆ hydrocarbyl)silyl. The term “polymer” includes both homopolymers, that is, polymers prepared from a single reactive monomer, and copolymers.

### DESCRIPTION OF THE PREFERRED EMBODIMENTS

The Composition:

The filled thermoplastic polyolefin composition of the invention comprises at least 20 percent by volume of an organic or inorganic filler, preferably an inorganic filler, based on the total volume of the composition. The filler preferably comprises at least 25, more preferably at least 30 and even more preferably at least 40, percent by volume based on the total volume of the composition. In some instances, the filler comprises at least 55 percent by volume based on the total volume of the composition. The total volume of the composition includes the volume of the filler, thermoplastic olefins and all other components, e.g., additives, of the composition.

The composition also contains a first polypropylene comprising a propylene/α-olefin copolymer as described below. The composition may also contain one or more additional polypropylenes that are different from the first polypropylene. The total minimum amount of polypropylene in the composition, i.e., either the first polypropylene alone or the first polypropylene in combination with one or more other polypropylenes, will vary with the end-use application of the composition.

For masterbatch applications, the polypropylene acts as a binder for the filler or additive, e.g., pigment, and sufficient polypropylene is used to allow good dispersion of the filler or additive through the polypropylene matrix, e.g., 5 volume percent. In these masterbatch applications, the maximum amount of polypropylene is more a factor of economics and convenience than anything else, and it typically does not exceed 15 volume percent, preferably it does not exceed 10 volume percent.

For other applications, e.g., wire and cable coverings, sound barriers, etc., a greater minimum amount of total polypropylene is typically require than that required in a masterbatch application because the polypropylene in these other applications serves as more than a binder. In these other applications, the polypropylene provides important physical properties, e.g., flexibility, mechanical strength, extrudability, etc., to the composition and as such, more polypropylene is usually present, e.g., a minimum of about 25 volume percent.

The Propylene/α-Olefin Copolymer:

The first polypropylene of the compositions of this invention comprises a propylene/α-olefin copolymer which is typically comprised of units derived from propylene in an amount of at least about 60 percent by weight of the copolymer. For propylene/ethylene copolymers, the units derived from propylene preferably comprise at least about 80, and more preferably at least about 85, percent by weight of the copolymer. For propylene/α-olefin copolymers which are terpolymers, the percent by weight of units derived from propylene preferably is at least 65, more preferably at least 70. The typical amount of units derived from the α-olefin (preferably ethylene) component of the propylene/α-olefin copolymers is at least 8, preferably at least 10 and more preferably at least 12, percent by weight. If a terpolymer is utilized, the combined total amount of units derived from the comonomers other than propylene preferably is from 10 to 35 percent by weight. The maximum amount of units derived from all α-olefins present in these copolymers is typically not in excess of 40, preferably not in excess of 35, more preferably not in excess of 30, and even more preferably not in excess of 25, percent by weight of the copolymer. Preferably for propylene/ethylene copolymers, the amount of units derived from ethylene is from 6 to 20, more preferably from 8 to 17 and even more preferably from 8 to 13, percent by weight. The α-olefin preferably is present at low enough levels to ensure adequate physical properties of the composition for its intended purpose.

For the purposes of this invention, the α-olefin includes C₈₋₄₀ vinyl aromatic compounds including sytrene, o-, m-, and p-methylstyrene and the like. Preferably, the α-olefins comprise ethylene and C₄₋₂₀ olefins, more preferably ethylene and C₄₋₁₂ olefins, most preferably ethylene.

In addition to the propylene and α-olefin, the copolymers may also contain other unsaturated comonomers. The other unsaturated comonomers which may be incorporated into the propylene/α-olefin copolymer include, but are not limited to, C₄₋₂₀ diolefins (preferably 1,3-butadiene or 1,3-pentadiene), norbomadiene, 5-ethylidene-2-norbornene (ENB), dicyclopentadiene, divinylbenzene, vinylbiphenyl, vinylnapthalene, and halogen-substituted C₈₋₄₀ vinyl aromatic compounds such as chlorostyrene and fluorostyrene.

The propylene/α-olefin copolymers described in U.S. Ser. No. 10/289,168, i.e., the P/E* polymers, are the preferred propylene/α-olefin copolymers for use as the first polypropylene in the practice of this invention. The P/E* polymers of particular interest include propylene/ethylene, propylene/1-butene, propylene/1-hexene, propylene/4-methyl-1-pentene, propylene/1-octene, propylene/ethylene/1-butene, propylene/ethylene/ENB, propylene/ethylene/1-hexene, propylene/ethylene/1-octene, propylene/styrene, and propylene/ethylene/styrene. The manufacture of these propylene/α-olefin copolymers is also described in U.S. Ser. No. 10/289,168.

Broad Composition Distribution:

The first polypropylene of the composition is characterized as having a broad composition distribution. The determination of this composition distribution, or crystallizable sequence length distribution, can be accomplished on a preparative scale by temperature-rising elution fractionation (TREF). The relative mass of individual fractions can be used as a basis for estimating a more continuous distribution. L. Wild, et al., Journal of Polymer Science: Polymer. Physics Ed., 20, 441 (1982), scaled down the sample size and added a mass detector to produce a continuous representation of the distribution as a function of elution temperature. This scaled down version, analytical temperature-rising elution fractionation (ATREF), is not concerned with the actual isolation of fractions, but with more accurately determining the weight distribution of fractions.

While TREF was originally applied to copolymers of ethylene and higher α-olefins, it can also be used for the analysis of copolymers of propylene with ethylene (or higher α-olefins). The analysis of copolymers of propylene requires higher temperatures for the dissolution and crystallization of pure, isotactic polypropylene, but most of the copolymerization products of interest elute at similar temperatures as observed for copolymers of ethylene. Table A below is a summary of conditions used for the analysis of copolymers of propylene. Except as noted the conditions for TREF are consistent with those of Wild, et al., ibid, and Hazlitt, Journal of Applied Polymer Science: Appl. Polym. Symp.,45, 25(1990).

TABLE A
Parameters Used for TREF

| Parameter | Explanation |
|---|---|
| Column type and size | Stainless steel shot with 1.5 cc |
| | interstitial volume |
| Mass detector | Single beam infrared detector at 2920 cm⁻¹ |
| Injection temperature | 150° C. |
| Temperature control device | GC oven |
| Solvent | 1,2,4 - trichlorobenzene |
| Concentration | 0.1 to 0.3% (weight/weight) |
| Cooling Rate 1 | 140° C. to 120° C. @ −6.0° C./min. |
| Cooling Rate 2 | 120° C. to 44.5° C. @ −0.1° C./min. |
| Cooling Rate 3 | 44.5° C. to 20° C. @ −0.3° C./min. |
| Heating Rate | 20° C. to 140° C. @ 1.8° C./min. |
| Data acquisition rate | 12/min. |

The data obtained from TREF are expressed as a normalized plot of weight fraction as a function of elution temperature. The separation mechanism is analogous to that of copolymers of ethylene, whereby the molar content of the crystallizable component (ethylene) is the primary factor that determines the elution temperature. In the case of copolymers of propylene, it is the molar content of isotactic propylene units that primarily determines the elution temperature. The Figure (which is FIG. 5 of U.S. Ser. No. 10/289,168) is a representation of the typical type of distribution one would expect for (i) a propylene/ethylene copolymer made with a metallocene catalyst, and (ii) an example of the distribution of a preferred first polypropylene used in the practice of the current invention, i.e., a propylene/α-olefin copolymer (a P/E* copolymer) described in U.S. Ser. No. 10/289,168.

The shape of the metallocene curve in the Figure is typical for a homogeneous copolymer. The shape arises from the inherent, random incorporation of comonomer. A prominent characteristic of the shape of the curve is the tailing at lower elution temperature compared to the sharpness or steepness of the curve at the higher elution temperatures. A statistic that reflects this type of assymetry is skewness. Equation 1 mathematically represents the skewness index, Sᵢₓ, as a measure of this asymmetry.

$${S}_{ix} = \frac{\sqrt[3]{\sum {w}_{i} * {( {T}_{i} - {T}_{Max} )}^{3}}}{\sqrt{\sum {w}_{i} * {( {T}_{i} - {T}_{Max} )}^{2}}} . \qquad Equation 1$$

The value, T_{Max}, is defined as the temperature of the largest weight fraction eluting between 50 and 90° C. in the TREF curve. Tᵢ and wᵢ are the elution temperature and weight fraction respectively of an abitrary, i^{th} fraction in the TREF distribution. The distributions have been normalized (the sum of the wᵢ equals 100%) with respect to the total area of the curve eluting above 30° C. Thus, the index reflects only the shape of the crystallized polymer, and any uncrystallized polymer (polymer still in solution at or below 30° C.) has been omitted from the calculation shown in Equation 1.

In addition to the skewness index, another measure of the breadth of the TREF curve (and therefore a measure of the breadth of the composition distribution of a copolymer) is the Median Elution Temperature of the final eluting quartile (T_{M4}). The Median Elution Temperature is the median elution temperature of the 25% weight fraction of the TREF distribution (the polymer still in solution at or below 30° C. is excluded from the calculation as discussed above for skewness index) that elutes last or at the highest temperatures. The Upper Temperature Quartile Range (T_{M4}-T_{Max}) defines the difference between the Median Elution Temperature of the final eluting quartile and the peak temperature T_{Max}. Referring to Table 7 of Example 7 of U.S. Ser. No. 10/289,168, the comparative copolymers made with a metallocene catalyst exhibit an Upper Temperature Quartile Range of from 1.5° C. to 4.0° C., with the majority being less than 3° C. The preferred propylene/α-olefin copolymers that comprise the first polypropylene used in the practice of the current invention, i.e., the P/E* copolymers of U.S. Ser. No. 10/289,168, have broad composition distributions, indicated, in-part, by Upper Temperature Quartile Range values of at least 4.0° C., preferably at least 4.5° C., more preferably at least 5° C., further more preferably at least 6° C., most preferably at least 7° C., and in some instances, at least 8° C. and even at least 9° C. In general, the higher the value for the Upper Temperature Quartile Range, the broader the composition distribution of the copolymer.

Molecular Weight Distribution:

The first polypropylene of the composition is also characterized as having a narrow molecular weight distribution. The molecular weight distribution (MWD) is the ratio (M_{w}/Mₙ) of weight average molecular weight (M_{w}) to number average molecular weight (Mₙ). The Mw/Mn of the propylene/α-olefin copolymers of the inventive composition are about ≦3.5, preferably about ≦3.0, more preferably about ≦2.8, more preferably about ≦2.5, and most preferably about ≦2.3. Molecular weight distribution for all the polymers of the invention are determined in accordance with the description provided below. The MWD of the propylene/α-olefin copolymers used in the practice of this invention is determined using gel permeation chromatography (GPC) according to the procedure described in U.S. Ser. No. 10/289,168.

Melt Flow Rate (MFR):

The polypropylenes, particularly the propylene/α-olefin copolymers, used in the practice of this invention, typically have an MFR of at least 0. 1, preferably at least 0.3, more preferably at least 0.5, further more preferably at least 1, and most preferably at least 1.5. The maximum MFR typically does not exceed 100, preferably it does not exceed about 50, more preferably it does not exceed about 40, and even more preferably it does not exceed about 30. MFR for the propylene/α-olefin copolymers and other polypropylenes used in the practice of this invention are measured according to ASTM D-1238, condition L (2.16 kg, 230 degrees C.).

The Filler:

The fillers used in the practice of this invention can be either organic or inorganic fillers. Organic fillers include such materials as cellulose, starch, pigment and color concentrates, flour, wood flour, and polymeric materials including the various hydrocarbon and substituted hydrocarbon polymers.

Inorganic fillers are the preferred fillers for use in this invention. Preferred examples of inorganic fillers are talc, calcium carbonate, aluminum trihydroxide, glass fibers, marble dust, cement dust, clay, feldspar, silica or glass, fumed silica, alumina, magnesium oxide, magnesium hydroxide, antimony oxide, zinc oxide, barium sulfate, aluminum silicate, calcium silicate, titanium dioxide, titanates, clay, nanoclay, organo-modified clay or nanoclay, glass microspheres and chalk. Of these fillers, barium sulfate, talc, calcium carbonate, silica/glass, glass fibers, alumina, aluminum trihydroxide, magnesium hydroxide and titanium dioxide, and mixtures thereof are preferred. The most preferred inorganic fillers are talc, magnesium hydroxide, aluminum trihydroxide, calcium carbonate, barium sulfate, glass fibers or mixtures thereof. For flame resistance application, the preferred flame-retardant fillers include magnesium hydroxide, calcium carbonate, aluminum trihydroxide (also referred to as alumina trihydrate) and mixtures of two or more of these materials.

For some applications the use of two or more fillers is preferred. Examples of useful filler blends include barium sulfate and calcium carbonate for sound barriers, and carbon black and calcium carbonate and/or talc for conductive flooring. The respective amount of each filler in these blends is well within the skill of the ordinary artisan.

The Optional or Second Polypropylene:

The optional polypropylene is stereoregular, preferably having isotactic, stereoregular propylene sequences. The optional polypropylene exhibits a heat of fusion higher than the heat of fusion for the first propylene/α-olefin copolymer.

The optional or second polypropylene used in the practice of this invention can comprise a random propylene copolymer, a propylene homopolymer, a propylene impact copolymer composition, a polypropylene copolymer, a P/E* polymer, and mixtures of two or more of these polypropylenes. Due to their ability to incorporate large quantities of filler, the optional polypropylene is typically and preferably a P/E* polymer different than the first polypropylene. While typically the first and second polypropylenes are similar to one another in structure and properties for reasons of compatibility and economy, e.g., two P/E* polymers, they may also differ significantly from one another, e.g., a P/E* polymer as the first polypropylene and a metallocene and/or a Ziegler-Natta catalyzed polymer as the optional polypropylene.

The optional polypropylene can be prepared by any conventional polypropylene production process known to those of ordinary skill in the art, and it can be made using a variety of catalysts including metallocene and Ziegler-Natta catalysts. In addition, the catalyst systems and processes used for making the preferred P/E* polymer of the first polypropylene (as described in U.S. Ser. No. 10/289,168) can also be used to make the optional or second polypropylene.

The optional polypropylene typically has a melt flow rate of from about 0.1 g/10 min to about 50 g/10 min. Preferably, the ratio of the intrinsic viscosity of the propylene/α-olefin copolymer to the intrinsic viscosity of the polypropylene is typically between about 0.1 and about 10. The intrinsic viscosity can be determined in accordance with ASTM D5225-98.

Preferably the optional polypropylene copolymer has from greater than about 0 to about 20 percent by weight units derived from an α-olefin, more preferably from about 3 to about 15 percent by weight units derived from an α-olefin, and most preferably from about 5 to about 10 percent by weight units derived from an α-olefin. Preferably, the α-olefin is selected from ethylene and C₄₋₂₀ α-olefins, more preferably from ethylene and C₄₋₁₂ α-olefins, even more preferably from ethylene and C₄₋₈ α-olefins, and most preferably ethylene. The optional polypropylene preferably has a molecular weight distribution about ≦3.5. More preferably, the polypropylene is a second propylene/α olefin copolymer having a molecular weight distribution ≦3.5 and a broad composition distribution. For theremoforming applications and compositions, the melting point Tₘₐₓ of the first propylene/α-olefin copolymer and the optional polypropylene are within about 100° C. of one another, more preferably within about 80° C., even more preferably within about 50° C., and for some applications within about 40° C. of one another.

If the optional polypropylene is a polypropylene copolymer, then preferably it has from about 3 to about 20 percent by weight units derived from an α-olefin with the α-olefin preferably matching the α-olefin of the first propylene/α-olefin copolymer component of the composition. For example, if the first polypropylene of the composition is a propylene/ethylene copolymer, then the optional polypropylene component preferably is a second propylene/ethylene copolymer having units derived from ethylene.

In those embodiments in which a blend of polypropylenes are use, the relative amount of each polypropylene in the composition can vary widely. Because of their ability to hold large quantities of filler, typically and preferably the majority, i.e., greater than about 50 weight percent, of the polypropylene blend comprises the first polypropylene. This may be particularly useful in masterbatch applications. However, for those embodiments in which mechanical and other properties may be more important that the ability to hold or disburse large amounts of filler, e.g., wire and cable coatings or sound barriers, the amount of first polypropylene in the polypropylene blend may be less than about 50 weight percent, e.g., 40, or even 30 or less, weight percent. The optimal amount of each polypropylene in the blend is well within the skill of the ordinary artisan to determine.

Other Additives:

The compositions of this invention also can include one or more additional components, such as polymer additives (e.g., antioxidants such as hindered phenols or phosphites), light stabilizers (e.g., hindered amines), antiblock and slip agents, plasticizers (e.g., dioctylphthalate or epoxidized soy bean oil), processing aids (e.g., oils, stearic acid or its metal salt), colorants or pigments, blowing agents, carbon black, and surface active agents, to the extent that the additive does not interfere with desired physical properties of the composition. The additives are employed in functionally equivalent amounts known to those skilled in the art, generally in amounts of up to about 30, preferably from about 0.01 to about 5, more preferably from about 0.02 to about 1, percent by weight, based upon the total weight of the filled thermoplastic olefin composition.

Additionally, organic acids and/or their salts can be added to the filled compositions to enhance their processability and to enhance the dispersion of the filler in the polypropylene. Here too, these additives are used in amounts know to those skilled in the art.

Composition Compounding and Article Fabrication:

The filled thermoplastic olefin compositions can be compounded by any convenient method, such as dry blending of the first and second polypropylenes, the filler(s) and optional additives, and subsequently melt mixing, either directly in an extruder used to make the finished article, or by pre-melt mixing in a separate extruder (for example, a Banbury mixer). Dry blends of the compositions can also be directly injection molded without pre-melt mixture.

Alternatively, the first and second polypropylenes may be blended prior to the incorporation of the filler. The blend can either be a physical blend or an in-reactor blend manufactured by in-reactor processes as known to those of ordinary skill in the art. Preferably, the filled thermoplastic olefin composition comprises the filler together with an in-reactor blend of a first propylene/α-olefin copolymer and a second propylene/α olefin copolymer. The in-reactor blend preferably is made using a series or parallel solution polymerization process as known to those of ordinary skill in the art and/or as described in U.S. Ser. No. 10/139,786.

The compositions can be processed to fabricate articles by any suitable means known in the art. For example, the filled thermoplastic olefin composition can be processed to films or sheets or to one or more layers of a multilayered structure by know processes, such as calendering, casting or co-extrusion. Injection molded, compression molded, extruded or blow molded parts can also be prepared from the filled thermoplastic olefin compositions of the present invention. Alternatively, the filled thermoplastic olefin compositions can be processed by profile extrusion processes to make articles, such as wire and cable, pipe and tubing, gaskets, and molded articles.

The compositions of this invention are also useful in the preparation of master batches. For example, the addition of pigment or color concentrates to a polymer is often through the use of a master batch. In this example, a first, and optionally second, polypropylene that is (are) compatible with the polymer to be colored, is highly filled with the pigment or concentrate to form a master batch, and then the master batch is added to the polymer to be colored. The compositions of this invention can contain more pigment or colorant than conventional compositions.

### EXAMPLES

The following examples show the improved physical properties exhibited by selected formulations of the inventive composition. Table 1 shows the physical properties for the invention compositions and comparative samples made using Ziegler-Natta polymers.

General Continuous Loop Solution Copolymerization Procedure Used to Prepare the Propylene/Ethylene Copolymers of Examples 1 and 2

P/E* S1-S3 copolymers were made according to the following procedure. Catalyst 12J of U.S. Ser. No. 10/289,168 was used to manufacture all of the propylene/α-olefin copolymers of Examples 1 and 2. The P/E* copolymers of Examples 1 and 2 have a broad composition distribution as described for Examples 2-6 of U.S. Ser. No. 10/289,168. Additionally, all the P/E* copolymers of Examples 1 and 2 have a MWD of about 2.5.

The propylene polymerization process is exothermic. There are about 900 BTU released per pound of propylene polymerized and about 1,500 BTU released per pound of ethylene polymerized. The primary process design consideration is the removal of the heat of reaction. The P/E* copolymers of Example 1 were produced in a low-pressure, solution polymerization loop reactor, made of a 3″ loop pipe plus two heat exchangers, the total volume of which is 26.9 gallons. Solvent and monomer (propylene) are injected into the reactor as a liquid. The comonomer (ethylene) gas is fully dissolved in the liquid solvent. The feed is cooled to 5° C. before injection into the reactor. The reactor operates at polymer concentrations equal to 18 wt%. The adiabatic temperature rise of the solution accounts for some of the heat removal from the polymerization reaction. Heat exchangers within the reactor are utilized to remove the remaining heat of reaction allowing for reactor temperature control at 105° C.

The solvent used is Isopar E, a high purity iso-paraffinic fraction purchased from Exxon. Fresh propylene is passed through a bed of Selexsorb COS for purification before mixing with the recycle stream (which contains solvent, propylene, ethylene and hydrogen). After mixing with the recycle stream, the combined stream is passed through a bed of 75 wt% Molecular Sieve 13X and 25 wt% Selexsorb CD for further purification before using a high pressure (700 psig) feed pump to pass the contents to the reactor. Fresh ethylene is passed through a Selexsorb COS bed for purification before compressing the stream to 750 psig. Hydrogen (a telogen used to reduce molecular weight) is mixed with the compressed ethylene before the two are mixed/dissolved into the liquid feed. The total stream is cooled to the appropriate feed temperature (5° C.). The reactor operates at 525 psig and a control temperature equal to 105° C. The propylene conversion in the reactor is maintained by controlling the catalyst injection rate. The reaction temperature is maintained by controlling the water temperature across the shell side of the heat exchanger at 85° C. The residence time in the reactor is short, about 15 minutes. The propylene conversion per reactor pass is 60 wt%.

Upon exiting the reactor, water and additives are injected into the polymer solution. The water hydrolyzes the catalyst, terminating the polymerization reaction. The additives consist of antioxidants, 500 ppm of Irganox™ 1010 and 1000 ppm of Irgafos™ 168, that remain with the polymer and act as stabilizers to prevent polymer degradation while in storage before subsequent fabrication at the end-user's facility. The post-reactor solution is super-heated from reactor temperature to 230° C. in preparation for a two-stage devolatilization. The solvent and unreacted monomers are removed during the devolatilization process. The polymer melt is pumped to a die for underwater pellet cutting.

Solvent and monomer vapors exiting the top of the devolatilizers are sent to a coalescer. The coalescer removes polymer entrained in the vapor during devolatilization. The clean vapor stream leaving the coalescer is partially condensed through a series of heat exchangers. The two-phase mixture enters a separation drum. The condensed solvent and monomers are purified (this is the recycle stream described above) and re-used in the reaction process. The vapors leaving the separating drum, mostly containing propylene and ethylene, are sent to a block flare and burned.

The Compositions

The samples reported in Table 1 below were prepared as follows:

A. Mixing

1. Weigh sample formulations on Satorius Balance model #BR 6100

For the samples containing 0% by weight filler:

| | |
|---|---|
| 983.68 g | Polymer |
| 51.99 g | Oil - Shellflex 6371 (marketed by Equilon Enterprises, LLC) |
| 3.12 g | Stearic Acid |
| 1.04 g | Irganox B225 |
| 0.0 g | CaCO₃ (0%) |

For the samples containing 60% by weight filler:

| | |
|---|---|
| 608.25 g | Polymer |
| 87.9 g | Oil - Shellflex 6371 (marketed by Equilon Enterprises, LLC) |
| 5.27 g | Stearic Acid |
| 1.76 g | Irganox B225 |
| 1054.77 g | CaCO₃ (60% by weight) |

For the samples containing 80% by weight filler:

| | |
|---|---|
| 256.66 g | Polymer |
| 87.9 g | Oil - Shellflex 6371 (marketed by Equilon Enterprises, LLC) |
| 5.27 g | Stearic Acid |
| 1.76 g | Irganox B225 |
| 1406.36 g | CaCO₃ (80% by weight) |

B. Blend Preparation

The blends were prepared using a Farrell BR1600 Banbury Mixer serial # 006077 which was pre-heated to 150 C. with a mixing speed of 65 rpm. The full quantity of polymer and the additives were added initially to the mixer. These components were assumed to be mixed once the polymer blend achieved a mixed temperature of 120° C., which typically took about 3 minutes. One half of the filler was added and the mixture was again allowed to reach a temperature of 120 C At this point the remaining filler was added and a blend was allowed to reach a temperature of 150 C and was removed from the mixer. The semi-molten polymer was cut into small pieces of approximately 15 grams each to aid in subsequent compression molding sequences.

C. Sample Preparation

Sample plaques (10″×10″×75 mil) were prepared using a Tetrahedron Compression Molder model #MTP-14 according to ASTM procedure D-1978 and using condition steps of:
1. 190 C, 4 min., 14,000 psi
2. 190 C, 6 min., 50,000 psi
3. 27 C, 5 min., 45,000 psi
   Tensile bars were obtained from the plaque by using a NAEF Punch Press model B #90018 and using a Type IV Lo—4.5″ tensile die as specified by ASTM method D-638-84. Flexural modulus test bars were likewise cut using a ½″×5″ rectangular die. Sample density test pieces were obtained by cutting a square sample of 2″×2.″ Shore A values were obtained by measuring the test plaque directly.
   D. Sample Testing Procedures

Prior to sample testing, the test pieces were allowed at least 48 hours of conditioning.

Tensile testing was performed using a MTS Sintech 5/G tensile tester using the procedure of ASTM D-638-84 and using Type IV Lo—4.5″ samples. A 2.5″ gauge length was employed, and the samples were pulled at a 20″/min rate. Reported values of ultimate tensile and % elongation are the average of 5 samples. The Flexural modulus values were obtained using an Instron model #4501 and following the procedure outlined in ASTM method D 790-02. A Durotronic 2000 Durometer model #902 was used to obtain Shore A values in accordance with ASTM-D 2240.

The density test piece was 5.08 cm×5.08 cm×thickness (cm) measured using a caliper to obtain thickness in cm on all four sides of the sample and then an average taken. The weight was measured using a Mettler Balance model #AE 200 in grams. Values were obtained by equation 1.

Equation 1:

Density (g/cm³)=weight (g)/(length (cm)*width (cm)*average thickness (cm)). The level of filler in the filled thermoplastic olefin composition may be described by weight or volume. The volume percent of the filler may be estimated by the equation:
vol percent_{F}=[(wt percent_{F}/r_{F})×100percent]/[(wt percent_{F}/r_{F})+S(wt percentᵢ/rᵢ)]
where vol percent_{F} is equal to the volume percent of the filler in the final composition, wt percent_{F} is equal to the weight percent of the filler; r_{F} is the density of the filler measured in grams per cubic centimeter (g/cm³); wt percentᵢ is the weight percent of the i^{th} component; rᵢ is the density of the i^{th} component measured in grams per cubic centimeter (g/cm³). For example, a formulation characterized as 80 weight percent filler (density=2.7 g/cm³), 19.7 weight percent propylene/α-olefin copolymer (density=0.86 g/cm³), and 0.3 weight percent organic acid (density=0.97 g/cm³) would have a volume percent of filler of:

$$\frac{( 80 / 2.7 ) 100 percent}{( 80 / 2.7 ) + ( 19.7 / 0.860 ) + ( 0.3 / 0.97 )} = 56.1 volume percent$$

E. Polymers

P/E* S1 is a propylene/ethylene copolymer made as described above, containing 8 percent by weight units derived from ethylene and having a melt flow rate of 2 g/10 min. This copolymer exhibits a heat of fusion of 47 Joules/gram.

P/E* S2 is a propylene/ethylene copolymer made as described above, containing 11 percent by weight units derived from ethylene and having a melt flow rate of 2 g/10 min.

P/E* S3 is a propylene/ethylene copolymer made as described above, containing 14 percent by weight units derived from ethylene and having a melt flow rate of 2 g/10 min. This copolymer exhibits a heat of fusion of 12 Joules/gram.

H110-02N is a nucleated mini-random propylene copolymer made with a Ziegler-Natta catalyst available from The Dow Chemical Company. H110-02N has 0.5 percent by weight units derived from ethylene and a melt flow rate of 2 g/10 min.

DS6D82 is a random propylene copolymer made with a Ziegler-Natta catalyst available from The Dow Chemical Company. DS6D82 has 5.7 percent by weight units derived from ethylene and a melt flow rate of 7 g/10 min.

AFFINITY KC 8852 is a 3 melt index (by ASTM D-1238, (2.16 kg, 190° C.)) ethylene/1-octene copolymer made with a constrained geometry catalyst having a density of 0.875 g/cc and available from The Dow Chemical Company.

Micro-White™ 100, 15 micron is a 15 micron particle size, dry ground marble available from IMERYS. The compound has approximately 95 percent CaCO₃.

### Example 1

Table 1 reports the results of the various testing conducted on the polymers described above.

TABLE 1A

| | Ultimate Elongation | | | | Ultimate Tensile | | | |
|---|---|---|---|---|---|---|---|---|
| | % at Break | | | | at Break (psi) | | | |
| MicroWhite 100, 15 micron | 0 wt % | 60 wt % | 80 wt % | Ratio 0 wt %/80 wt % | 0 wt % | 60 wt % | 80 wt % | Ratio 0 wt %/80 wt % |
| 67% P/E* S2, 33% P/E* S1 | 797 | 698 | 568 | 71.3% | 2011 | 1090 | 278 | 13.8% |
| 67% P/E* S3, 33% P/E* S1 | 809 | 684 | 622 | 76.9% | 1468 | 579 | 168 | 11.4% |
| 67% P/E* S3, 33% P/E* S2 | 835 | 877 | 735 | 88.0% | 1202 | 646 | 132 | 11.0% |
| P/E* S2 | 847 | 743 | 673 | 79.5% | 2101 | 929 | 290 | 13.8% |
| P/E* S3 | 847 | 1047 | 50 | 5.9% | 768 | 359 | 79 | 10.3% |
| H110-02N | 114 | 21 | 6 | 5.3% | 6548 | 1900 | 398 | 6.1% |
| DS6D82 | 187 | 63 | 25 | 13.4% | 5239 | 1021 | 374 | 7.1% |

TABLE 1B

| | Flexural Modulus (psi) | | | | Shore A | | | |
|---|---|---|---|---|---|---|---|---|
| MicroWhite 100, 15 micron | 0 wt % | 60 wt % | 80 wt % | Ratio 0 wt %/80 wt % | 0 wt % | 60 wt % | 80 wt % | Ratio 0 wt %/80 wt % |
| 67% P/E* S2, 33% P/E* S1 | 8420 | 11080 | 24350 | 289.2% | 82.5 | 85.7 | 87.7 | 106.3% |
| 67% P/E* S3, 33% P/E* S1 | 3016 | 5620 | 9850 | 326.6% | 72.2 | 77.3 | 83.8 | 116.1% |
| 67% P/E* S3, 33% P/E* S2 | 1650 | 3610 | 5160 | 312.7% | 62.2 | 75.2 | 83.3 | 133.9% |
| P/E* S2 | 6390 | 7060 | 14060 | 220.0% | 78.4 | 84.8 | 85.7 | 109.3% |
| P/E* S3 | 890 | 1750 | 2220 | 249.4% | 55.9 | 66.8 | 71.3 | 127.5% |
| H110-02N | | | | | 89.6 | 90.1 | 91.4 | 102.0% |
| DS6D82 | 55420 | 140100 | 206800 | 373.2% | 88.3 | 91.5 | 91 | 103.1% |

TABLE 1C

| | Filler Volume % | | |
|---|---|---|---|
| MicroWhite 100, 15 micron | 0 wt % | 60 wt % | 80 wt % |
| 67% P/E* S2, 33% P/E* S1 | 0% | 32.7% | 56.4% |
| 67% P/E* S3, 33% P/E* S1 | 0% | 32.5% | 56.2% |
| 67% P/E* S3, 33% P/E* S2 | 0% | 32.4% | 56.2% |
| P/E* S2 | 0% | 32.6% | 56.3% |
| P/E* S3 | 0% | 32.3% | 56.1% |
| H110-02N | 0% | 33.3% | 57.2% |
| DS6D82 | 0% | 33.3% | 57.2% |

TABLE 1D

| Density | g/cm³ |
|---|---|
| MicroWhite 100 | 2.700 |
| 67% P/E* S2, 33% P/E* S1 | 0.872 |
| 67% P/E* S3, 33% P/E* S1 | 0.863 |
| 67% P/E* S3, 33% P/E* S2 | 0.863 |
| P/E* S2 | 0.869 |
| P/E* S3 | 0.860 |
| H110-02N | 0.900 |
| DS6D82 | 0.900 |

The data of Table 1 indicate the improved properties of the compositions of this invention. In particular, the data demonstrates that the inventive compositions can incorporate greater than 30 percent by volume filler, and in most instances greater than 55 volume percent filler while still maintaining acceptable physical properties. Even at greater than 55 percent by volume filler, several of the inventive compositions exhibit an ultimate tensile strength of at least 100 psi, while exhibiting an elongation at break of at least 500 percent, a Shore A of less than 90, and flexural modulus of greater than 4,000 psi. Additionally, the inventive filled thermoplastic olefin compositions maintained a much better balance of Ultimate elongation, Ultimate tensile, flexural modulus, and Shore A with filler than the comparative Ziegler-Natta produced propylene-ethylene copolymers.

### Example 2

The following compositions were prepared on a Brabender™ mixer equipped with a 250-ml mixing bowl. In each case, the mixer was set to a mixing temperature of 150 C and mixing rate of 50 rpm and mixed for four minutes, lowering the rpm if necessary to maintain a melt temperature of less than 175 C. The compositions were then removed from the Brabender mixer, allowed to cool to room temperature, and granulated for use as described below.

Each formulation was extruded at 170 C into 0.020 inch-thick tape. Tensile bars (ASTM D638 type IV) were prepared from the tapes and were allowed to stand at room temperature for one week. Tensile strength and elongation were then measured using an Instron™ at a strain rate of 20 inches per minute according to ASTM D638.

Rheology of the compositions was evaluated on a commercially available dual barrel capillary rheometer at 170 C with a 16:1 L/D die, and data were corrected for entrance effects. Additionally, some of the specimens were tested for oxygen index, according to ASTM D2863 using ¼×5×⅛ inch specimens. Melt flow rates were measured according to ASTM D1238 (modified to 170 C/21.6 kg). Hot deformation was run on 0.050 inch thick specimens as follows: The test apparatus was a Randal & Stickney (Waltham, Mass.) micrometer gauge weighted with a 2000 g load. A sample plaque was placed between the foot and the base of the dial gauge, and a reading was taken at room temperature. Next, the sample was placed in a 90 C oven for one hour, and a second reading was taken to calculate the percentage of change in the thickness of the sample.

As can be seen from Table 2, the flame-retardant compositions made with propylene/α-olefin copolymers of the invention have similar values for ultimate tensile strength and elongation as the flame-retardant compositions made from the ethylene/α-olefin copolymer and the ethylene-vinyl acetate (EVA) copolymer. However, the P/E* flame-retardant compositions exhibit lower values for viscosity than the ethylene/α-olefin copolymer and the EVA. This lowering of viscosity is an important factor in the processability of flame-retardant compositions. Further, as can be seen from Table 2, the P/E* copolymers show a lower increase in viscosity as filler is added. It is believed that this tendency will also be applicable at higher levels of filler loading, leading to more of an advantage in viscosity values compared to the propylene/ethylene and EVA polymers. Additionally, the P/E* polymers show a flame retardant effect, as indicated by the higher value of oxygen index compared to unfilled polymers, exhibiting an oxygen index of greater than 20%, preferably greater than 23%.

TABLE 2

| | Example | | | | | | | |
|---|---|---|---|---|---|---|---|---|
| | 1 | 2 | 3 | 4 | 5 | 6 | 7 | 8 |
| Compositions (% by weight): | | | | | | | | |
| Affinity KC8852 (PE) | 99.80 | 49.80 | | | | | | |
| EVA (28% VA, 3 MI)) | | | 99.80 | 49.80 | | | | |
| P/E* S2 | | | | | 99.80 | 49.80 | | |
| P/E* S1 | | | | | | | 99.80 | 49.80 |
| Irganox 1010 FF antioxidant | 0.10 | 0.10 | 0.10 | 0.10 | 0.10 | 0.10 | 0.10 | 0.10 |
| Irgafos 168 antioxidant | 0.10 | 0.10 | 0.10 | 0.10 | 0.10 | 0.10 | 0.10 | 0.10 |
| Aluminum trihydroxide | | 50.00 | | 50.00 | | 50.00 | | 50.00 |
| Results: | | | | | | | | |
| Oxygen index (%) | | | | | 20 | 24 | 20 | 24 |
| Hot deformation (%) | | 100 | | 100 | | 14 | | 0 |
| Ultimate tensile strength psi | 3539 | 1638 | 4830 | 1920 | 3844 | 1630 | 3224 | 2139 |
| % Retained versus unfilled formulation | | 46 | | 40 | | 42 | | 66 |
| Ultimate elongation % | 746 | 754 | 699 | 596 | 754 | 737 | 767 | 702 |
| % Retained versus unfilled formulation | | 101 | | 85 | | 98 | | 92 |
| Viscosity 1000 s-1 and 170° C. (Pa-s) | 332 | 551 | 216 | 457 | 267 | 280 | 250 | 275 |
| % increase viscosity versus unfilled formulation | | 66% | | 112% | | 5% | | 10% |
| Viscosity 200 s-1 and 170° C. (Pa-s) | 980 | 1610 | 595 | 1310 | 815 | 1285 | 820 | 1180 |
| % increase viscosity versus unfilled formulation | | 64% | | 120% | | 58% | | 44% |
| Flow Index g/10 min. (170° C., 21.6 kg) | 47 | 26 | 90 | 28 | 29 | 15 | 31 | 18 |
| % change in MFI versus unfilled formulation | | −45 | | −69 | | −48 | | −42 |

In addition to the aluminum trihydroxide used in this example, the flame-retardant compositions may contain any flame-retardant additives, fillers, or combinations of these materials. Specific examples include magnesium dihydroxide, red phosphorus, silica, alumina, titanium oxides, talc, clay, organo-modified clay, zinc borate, antimony trioxide, wollastonite, mica, silicone polymers, phosphate esters, hindered amine stabilizers, ammonium octamolybdate, intumescent compounds, expandable graphite, decabromodiphenyl oxide, decabromodiphenyl ethane, ethylene-bis (tetrabromophthalimide), and dechlorane plus. Other suitable flame retardants will be readily apparent to those skilled in the art. In addition, the composition may contain other additives such as antioxidants, stabilizers, blowing agents, carbon black, pigments, processing aids, peroxides, cure boosters, and surface active agents to treat fillers. The preferred flame-retardant compositions have an oxygen index of greater than about 21% when measured according to ASTM D2863.

Although the invention has been described in considerable detail through the specification and examples, one skilled in the art can make many variations and modifications without departing from the spirit and scope of the invention as described in the following claims. All U.S. patents and U.S. allowed patent applications cited in the specification and examples are incorporated herein by reference.

1. A filled thermoplastic olefin composition comprising:
(a) a first polypropylene having substantially isotactic propylene sequences and exhibiting a narrow molecular weight distribution and a broad composition distribution; and
(b) at least 20 percent by volume of a filler based on the total volume of the composition.

2. The composition of claim 1 in which the first polypropylene is a propylene/α-olefin copolymer.

3. The composition of claim 2 in which the α-olefin of the propylene/α-olefin copolymer is ethylene or a C₄₋₂₀ α-olefin.

4. The composition of claim 3 in which the propylene/α-olefin copolymer is comprised of units derived from propylene in an amount of at least about 60 percent by weight of the copolymer.

5. The composition of claim 4 in which the propylene/α-olefin copolymer comprises at least about 3 percent by weight of units derived from the α-olefin, and has a molecular weight distribution ≦3.5.

6. The composition of claim 5 in which the propylene/α-olefin copolymer is characterized as having at least one of the following properties: (i) ¹³C NMR peaks corresponding to a regio-error at about 14.6 and about 15.7 ppm, the peaks of about equal intensity, (ii) a DSC curve with a Tₘₑ that remains essentially the same and a Tₘₐₓ that decreases as the amount of comonomer in the copolymer is increased, and (iii) a skewness index, Sᵢₓ, greater than about −1.20.

7. The composition of claim 1 comprising a second polypropylene which is different than the first polypropylene.

8. The composition of claim 7 in which the second polypropylene is a propylene/α-olefin copolymer.

9. The composition of claim 7 in which the second polypropylene has a heat of fusion higher than the heat of fusion for the first propylene/α-olefin copolymer.

10. The composition of claim 7 in which the filler comprises at least about 40 percent by volume of the composition.

11. The composition of the claim 1 in which the filler is an inorganic filler.

12. The composition of the claim 7 in which the filler is an inorganic filler.

13. The composition of the claim 1 in which the filler is a flame retardant inorganic filler.

14. The composition of the claim 7 in which the filler is a flame retardant inorganic filler.

15. A filled thermoplastic olefin composition comprising:
(a) a first polypropylene comprising a propylene/α-olefin copolymer having (i) at least about 60 percent by weight units derived from propylene, and from about 5 to about 17 percent by weight of units derived from an α-olefin, (ii) a molecular weight distribution about ≦3.5, and (iii) a broad composition distribution;
(b) a second polypropylene different from the first propylene; and
(c) at least 20 percent by volume of an inorganic filler based on the total volume of the composition.

16. The composition of claim 15 in which the second polypropylene comprises a propylene/α-olefin copolymer.

17. The composition of claim 16 in which the α-olefin of both the first and second propylene/α-olefin copolymers is ethylene or a C₄₋₂₀ α-olefin.

18. The composition of claim 17 in which the first propylene/α-olefin copolymer is further characterized as having at least one of the following properties: (i) ¹³C NMR peaks corresponding to a regio-error at about 14.6 and about 15.7 ppm, the peaks of about equal intensity, (ii) a DSC curve with a Tₘₑ that remains essentially the same and a Tₘₐₓ that decreases as the amount of comonomer in the copolymer is increased, and (iii) a skewness index, Sᵢₓ, greater than about −1.20, and the second propylene/α-olefin copolymer is made by either metallocene or Ziegler-Natta catalysis.

19. The composition of claim 18 in which the filler is an inorganic filler.

20. The composition of claim 19 in which the filler is a flame-retardant inorganic filler.

21. A flame retardant composition comprising:
(a) a propylene/α-olefin copolymer having (i) at least about 60 percent by weight units derived from propylene and from about 5 to about 15 percent by weight units derived from an α-olefin, (ii) a molecular weight distribution about ≦3.5, and (iii) a broad composition distribution; and
(b) at least 20 percent by volume of an inorganic flame retardant based on the total volume of the composition.

22. The composition of claim 21 in which the filler comprises at least about 55 volume percent.

23. The composition of claim 22 in which the filler is at least one of magnesium hydroxide, calcium carbonate and aluminum trihydroxide.

24. The composition of claim 1 in the form of a covering for a wire or cable.

25. The composition of claim 7 in the form of a covering for a wire or cable.

26. The composition of claim 21 in the form of a covering for a wire or cable.

27. The composition of claim 7 in which the first polypropylene comprises at least about 50 weight percent of the total weight of the polypropylene in the composition.

28. The composition of claim 1 in the form of a sound barrier.

29. The composition of claim 7 in the form of a sound barrier.

30. The composition of claim 1 in the form of a masterbatch.

31. The composition of claim 7 in the form of a masterbatch.
